(19) United States
(12) Patent Application Publication
(10) Pub. No.: US 2024/0393273 A1
(43) Pub. Date: Nov. 28, 2024

(54) INTERFACE INFORMATION IDENTIFICATION DEVICE, INTERFACE INFORMATION IDENTIFICATION METHOD, PROGRAM, INTERNAL INFORMATION IDENTIFICATION DEVICE, AND OPTICAL HEATING DEVICE

(71) Applicant: National University Corporation Tokai National Higher Education and Research System, Aichi (JP)

(72) Inventors: Hosei NAGANO, Aichi (JP); Takuya ISHIZAKI, Aichi (JP); Ryohei FUJITA, Aichi (JP)

(73) Assignee: National University Corporation Tokai National Higher Education and Research System, Aichi (JP)

(21) Appl. No.: 18/693,944

(22) PCT Filed: Sep. 21, 2022
(86) PCT No.: PCT/JP2022/035090

§ 371 Date: Mar. 20, 2024

(30) Foreign Application Priority Data
Sep. 21, 2021 (JP) 2021-153689

(51) Int. Cl. G01N 25/18; G01N 25/72

(52) U.S. Cl. CPC G01N 25/18; G01N 25/72

(57) ABSTRACT

An interface information identification device of the present disclosure includes: a light source configured to emit light to heat a sample, the sample including a first layer and a second layer overlapping the first layer; an irradiating unit configured to homogenize an intensity distribution of light from the light source to irradiate an entire surface of the first layer of the sample with the light; a detecting unit configured to detect a temperature distribution on a surface of the second layer of the sample; and an identifying unit configured to identify information about an interface between the first layer and the second layer of the sample based on the temperature distribution detected by the detecting unit.

### TECHNICAL FIELD

The present invention relates to an interface information identification device, an interface information identification method, a program, an internal information identification device, and an optical heating device.

### BACKGROUND ART

Patent Literature 1 discloses, in measuring an interface thermal resistance of an interface between laminates or thin films of a two-layer sample consisting of a monolayer sample composed only of a first substance and a monolayer sample composed only of a second substance, observing a temperature response after pulsed heating of a surface of the monolayer sample composed only of the first substance and a temperature response after pulsed heating of a surface of the monolayer sample composed only of the second substance.

Patent Literature 2 discloses a thermoelectric material measurement device. The thermoelectric material measurement device includes an optical camera to capture images of a measurement surface of a material to be measured, a probe equipped with a heater, a stage mechanism to place the material to be measured thereon and position a measurement point, a control device to drive these components, and a data processing device to process measurement data. The thermoelectric material measurement device collects a local thermal conductivity, thermoelectric power, and surface optical image of the sample to be measured in a single measurement and analyzes correlation between two-dimensional planar position information and thermophysical property values. The thermoelectric material measurement device measures the local thermal conductivity and thermoelectric power of the sample to be measured by accurately estimating a surface temperature of the sample to be measured at a probe contact point using the heat flow measured by a micro heat flow meter incorporated in the heated probe.

### CITATION LIST

### Patent Literature

Patent Document 1: Japanese Patent Application Laid-Open Publication No. 2001-116711
Patent Document 2: Japanese Patent Application Laid-Open Publication No. 2008-051744

### SUMMARY OF INVENTION

### Technical Problem

In order to, for example, reduce interface thermal resistance, it is necessary to understand the mechanism of how the interface thermal resistance is generated. In order to clarify this generation mechanism, for example, new approaches may be required to obtain information about an interface of samples.

The techniques disclosed herein aim to obtain information about an interface of samples using a new approach.

### Solution to Problem

With the above object in view, the techniques disclosed herein relate to an interface information identification device including: a light source configured to emit light to heat a sample, the sample including a first layer and a second layer overlapping the first layer; an irradiating unit configured to homogenize an intensity distribution of light from the light source to irradiate an entire surface of the first layer of the sample with the light; a detecting unit configured to detect a temperature distribution on a surface of the second layer of the sample; and an identifying unit configured to identify information about an interface between the first layer and the second layer of the sample based on the temperature distribution detected by the detecting unit.

The irradiating unit may include a guide body configured to guide light from the light source toward the sample while spreading the light to make an irradiation area of the light reaching the sample larger than the sample.

The irradiating unit may include a multimode fiber configured to receive and propagate light from the light source and output the light toward the guide body.

The interface information identification device may further include a changing unit configured to cause the sample and the guide body to move relative to each other to change a size of the irradiation area of the light reaching the sample.

The interface information identification device may further include an opening body between the sample and the detecting unit, the opening body including an opening allowing for passage therethrough of infrared rays that go from the surface of the second layer of the sample toward the detecting unit.

The opening body may be larger than the sample and the opening of the opening body may be smaller than the sample.

The detecting unit may be configured to detect a temperature distribution at a center of the surface of the second layer of the sample, excluding edges of the surface.

The information about the interface may include information about an interface thermal resistance.

The interface information identification device may further include a displaying unit configured to display the information about the interface identified by the identifying unit as a distribution at the interface.

The sample may include an adhesive layer between the first layer and the second layer, the adhesive layer bonding the first layer and the second layer, and the identifying unit may be configured to output, based on the identified information about the interface between the first layer and the second layer, information about an interface thermal resistance between the first layer and the adhesive layer.

The identifying unit may be configured to identify information about fatigue of the sample based on the temperature distribution detected by the detecting unit.

From another standpoint, the techniques disclosed herein relate to an interface information identification method including steps of: emitting light to heat a sample, the sample including a first layer and a second layer overlapping the first layer; homogenizing an intensity distribution of the emitted light to irradiate an entire surface of the first layer of the sample with the light; detecting a temperature distribution on a surface of the second layer of the sample; and identifying information about an interface between the first layer and the second layer of the sample based on the detected temperature distribution.

From still another standpoint, the techniques disclosed herein relate to a program for causing a computer to execute functions of: emitting light to heat a sample, the sample including a first layer and a second layer overlapping the first layer; homogenizing an intensity distribution of the emitted light to irradiate an entire surface of the first layer of the sample with the light; detecting a temperature distribution on a surface of the second layer of the sample; and identifying information about an interface between the first layer and the second layer of the sample based on the detected temperature distribution.

From still another standpoint, the techniques disclosed herein relate to an internal information identification device including: a light source; an irradiating unit configured to homogenize an intensity distribution of light emitted from the light source toward a sample to irradiate an entire surface of the sample with the light; a detecting unit configured to detect a temperature distribution on a back side of the sample; and an identifying unit configured to identify information about an internal condition of the sample based on the temperature distribution detected by the detecting unit.

The identifying unit may be configured to identify information about a through-plane thermal diffusivity of the sample based on at least one of an amplitude and a phase lag of the temperature distribution detected by the detecting unit.

The identifying unit may be configured to identify information about fatigue inside the sample based on the temperature distribution detected by the detecting unit.

From still another standpoint, the techniques disclosed herein relate to an optical heating device including: a light source configured to emit light to heat a sample; a multimode fiber configured to receive light from the light source at one end thereof and homogenize an intensity distribution of the propagating light; and a guide body provided at an other end of the multimode fiber, the guide body being configured to guide the light from the multimode fiber toward the sample while spreading the light.

### Advantageous Effects of Invention

The techniques disclosed herein can obtain information about an interface of samples using a new approach.

### BRIEF DESCRIPTION OF DRAWINGS

FIG. 1 illustrates a schematic configuration of an interface thermal resistance measurement device according to an embodiment.

FIG. 2 illustrates a functional configuration of a computer.

FIG. 3 illustrates an example hardware configuration of the computer.

FIG. 4 illustrates a configuration of a sample to be measured.

FIG. 5 illustrates a configuration of a support.

FIG. 6 (A) illustrates a configuration of a second stage, and (B) illustrates relationship between laser light and the sample to be measured.

FIG. 7 illustrates the principle of measuring interface thermal resistance according to the embodiment.

FIG. 8 illustrates the principle of measuring thermal diffusivity according to the embodiment.

FIG. 9 is a flowchart of an operation of the interface thermal resistance measurement device.

FIG. 10 illustrates first measurement results.

FIG. 11 illustrates second measurement results.

FIG. 12 illustrates third measurement results.

FIG. 13 illustrates the principle of measuring interface thermal resistance of a three-layer sample to be measured.

FIG. 14 is a flowchart illustrating a fatigue evaluation process by the interface thermal resistance measurement device.

FIG. 15 illustrates changes in fatigue evaluation with respect to a load count.

FIG. 16 illustrates the thermal diffusivity distribution for each load count.

FIG. 17 illustrates changes in the thermal diffusivity distribution with respect to a load count.

FIG. 18 illustrates a damage occurrence prediction image presented in a display area.

### DESCRIPTION OF EMBODIMENTS

An exemplary embodiment will now be described with reference to the drawings.

### <Configuration of Interface Thermal Resistance Measurement Device 1>

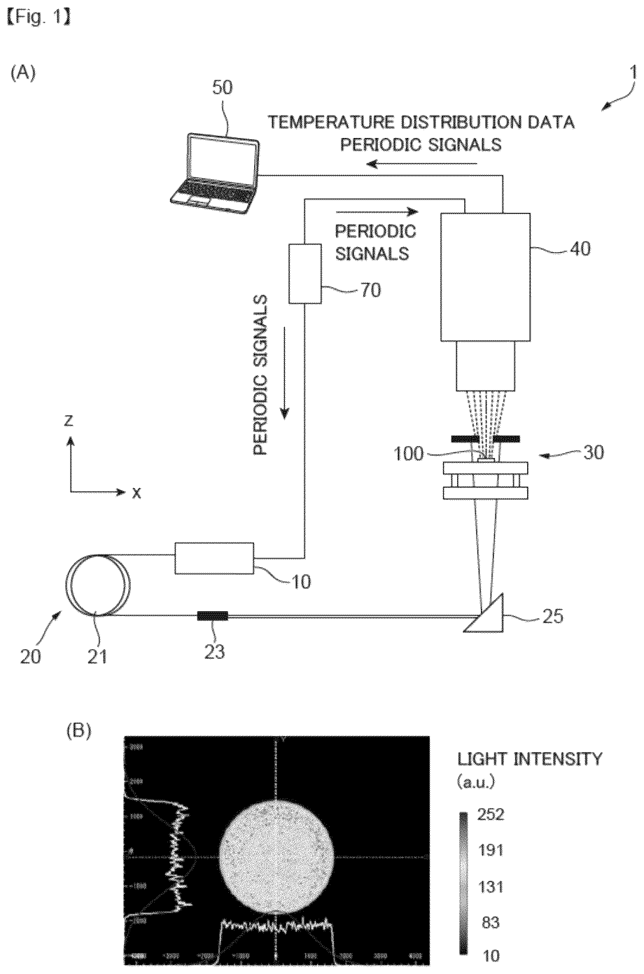

FIG. 1 illustrates a schematic configuration of an interface thermal resistance measurement device 1 according to the present embodiment.

First, referring to FIG. 1, a configuration of the interface thermal resistance measurement device 1 according to the present embodiment will be described.

As shown in FIG. 1, the interface thermal resistance measurement device 1 according to the present embodiment includes a diode laser 10 serving as a light source for heating a sample 100 to be measured (hereinafter the “measurement sample 100”), a light guide 20 for directing laser light of the diode laser 10 to the measurement sample 100, a support 30 (details to follow) for supporting the measurement sample 100, an infrared thermographic camera (lock-in thermographic camera) 40 located opposite the measurement sample 100, a computer 50 for receiving signals from the infrared thermographic camera 40, and a periodic signal generator 70 for generating periodic signals and outputs them to the diode laser 10 and the computer 50.

The diode laser 10 and the light guide 20 irradiate a surface of the measurement sample 100 with light having a uniform intensity distribution.

The diode laser 10 is a surface heating light source. The diode laser 10 outputs so-called multimode diode laser light (e.g., TEM01) whose transverse mode is not a single mode (TEM00).

The light guide 20 includes a fiber 21 as a transmission path for the laser light emitted from the diode laser 10, a condenser 23 located at the distal end of the fiber 21 to control the intensity distribution of the laser light emitted from the fiber 21, and a mirror 25 for reflecting the laser light emitted from the condenser 23.

The fiber 21 is composed of a multimode fiber capable of propagating laser light of different spatial modes in a mixed manner. Inside this fiber 21, the incident angle of the laser light emitted from the diode laser 10 is controlled to split the laser light into meridional and skew rays. The laser light emitted from the diode laser 10 repeatedly undergoes multiple reflections inside the fiber 21, resulting in a uniform intensity distribution on the irradiation plane. The fiber 21 in the illustrated example has a core diameter of 100 μm and a length of 3 m.

The condenser 23 is composed of a plurality of lenses or the like and serves as a variable focus condenser optic. The condenser 23 focuses (or diffuses) the laser light emitted from the fiber 21. The laser light emitted from the condenser 23 propagates through the space while spreading. Thus, the condenser 23 can be viewed as a beam expander that expands the beam diameter of the laser light emitted from the fiber 21.

The mirror 25 is composed of a well-known optical mirror, such as a glass substrate coated with a thin metal or dielectric film. The mirror 25 reflects the laser light emitted from the condenser 23 toward the measurement sample 100.

In a periodic heating method, the interface thermal resistance measurement device 1 configured as above homogenizes the irradiation power distribution for the sample by using a multimode for the laser and its transmission path, and derives a thermal resistance value from the results of thermographic measurement of the interface thermal distribution. To further illustrate, the laser light emitted from the diode laser 10 of the interface thermal resistance measurement device 1 impinges on the measurement sample 100 through the fiber 21, the condenser 23, and the mirror 25. The measurement sample 100 is periodically heated by the laser light. As shown in FIG. 1(B), the laser light going through the fiber 21, the condenser 23, and the mirror 25 is controlled such that the intensity distribution on the irradiation plane is homogenized into a so-called top-hat type intensity distribution.

The temperature of the measurement sample 100, which is periodically heated by the laser light from the diode laser 10, is measured by the infrared thermographic camera 40 from the back side of the measurement sample 100. The infrared thermographic camera 40 captures (measures) a predetermined area in the region periodically heated by the diode laser 10 as an infrared image. The infrared thermographic camera 40 receives periodic signals input from the periodic signal generator 70. The temperature distribution data, which is the data of the temperature measured by the infrared thermographic camera 40, is output to the computer 50.

The computer 50, in combination with the infrared thermographic camera 40, continuously captures infrared images and performs computations at predetermined frame rate intervals to create an averaged image based on the amount of temperature change over time (lock-in method). To further illustrate, the data obtained from the infrared thermographic camera 40 is processed by the computer 50 to calculate a through-plane thermal diffusivity of the measurement sample 100. The data obtained from the infrared thermographic camera 40 is also processed by the computer 50 to calculate an interface thermal resistance (details to follow) at an interface 101 (described below).

Note that the direction along the surface of the measurement sample 100 in FIG. 1, namely the horizontal direction in the figure may be referred to as the x-direction. The vertical direction in FIG. 1 may be referred to as the z-direction. The direction going into the page of FIG. 1 may be referred to as the y-direction.

### <Functional Configuration of Computer 50>

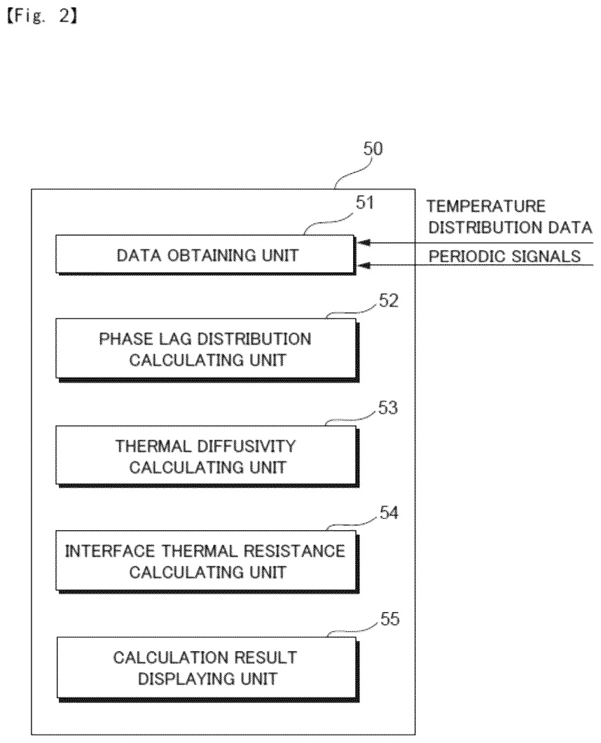

FIG. 2 illustrates a functional configuration of the computer 50.

Referring now to FIGS. 1 and 2, a functional configuration of the computer 50 according to the present embodiment will be described.

As shown in FIG. 2, the computer 50 according to the present embodiment includes: a data obtaining unit 51 to obtain temperature distribution data and periodic signals input from the infrared thermographic camera 40 (see FIG. 1); a phase lag distribution calculating unit 52 to calculate a phase lag distribution based on the temperature distribution data and periodic signals obtained by the data obtaining unit 51; a thermal diffusivity distribution calculating unit 53 to calculate a thermal diffusivity distribution based on the calculated phase lag; an interface thermal resistance calculating unit 54 to calculate an interface thermal resistance based on the measured amplitude; and a calculation result displaying unit 55 to display the results of the calculated thermal diffusivity and interface thermal resistance on a liquid crystal display (not shown).

The thermal diffusivity distribution calculating unit 53 calculates the thermal diffusivity based on Equation (8) described below. The interface thermal resistance calculating unit 54 calculates the interface thermal resistance based on Equations (13) and (14) described below. To further illustrate, the present embodiment allows for calculation of one of the thermal diffusivity and the interface thermal resistance when the other is known. To further illustrate, the present embodiment allows for selection of which of the thermal diffusivity and the interface thermal resistance is to be calculated.

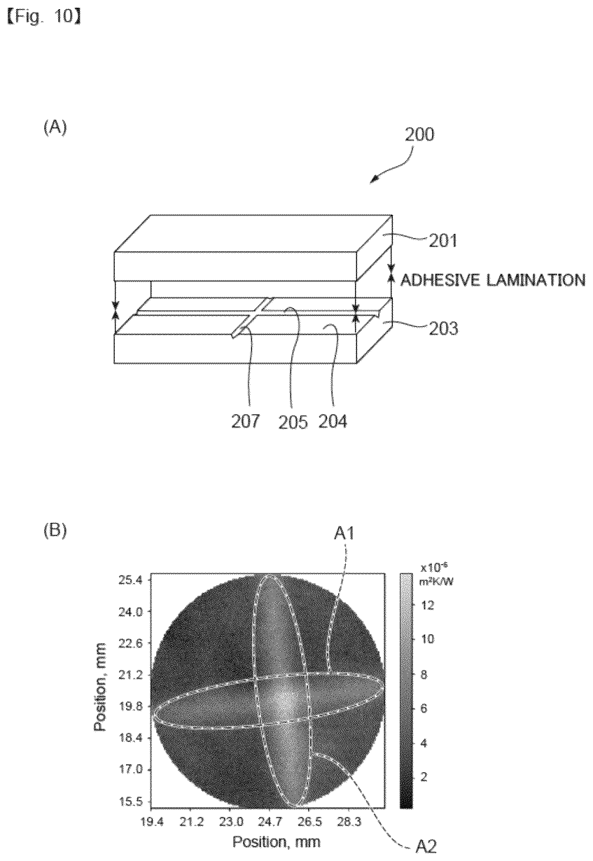

The computer 50 of the present embodiment calculates the distribution of interface thermal resistance at the interface 101 (described below) of the measurement sample 100 (see FIG. 1) based on the temperature distribution in the measurement sample 100 detected by the infrared thermographic camera 40. To further illustrate, the computer 50 identifies the state of contact between multiple members constituting the measurement sample 100 based on the amplitude of changes in temperature distribution in the measurement sample 100 as well as the delay in response. The computer 50 also calculates the distribution of through-plane thermal diffusivity in the measurement sample 100 (see FIG. 1) based on the temperature distribution in the measurement sample 100 detected by the infrared thermographic camera 40. The computer 50 also displays the results of calculation of the interface thermal resistance distribution and thermal diffusivity distribution on the liquid crystal display (not shown) (see FIG. 10 through FIG. 12 below), etc.

### <Hardware Configuration of Computer 50>

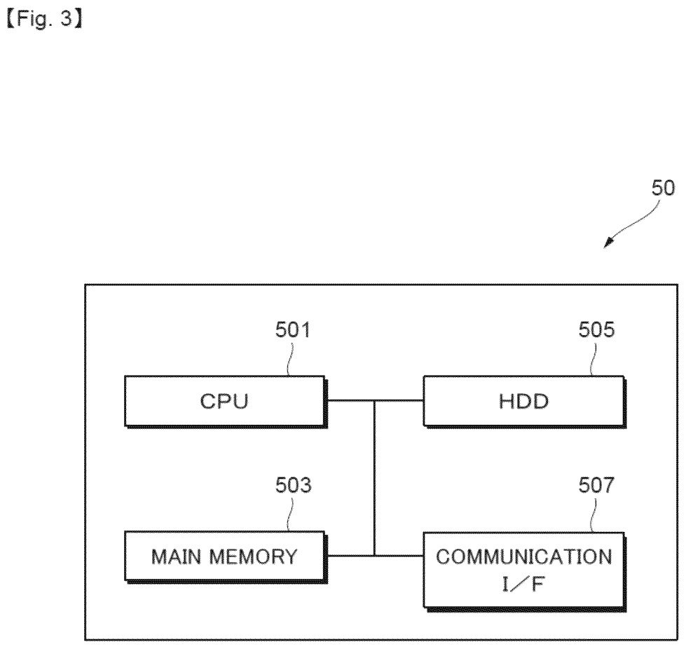

FIG. 3 illustrates an example hardware configuration of the computer 50.

As shown in FIG. 3, the computer 50 includes a central processing unit (CPU) 501 as an arithmetic means, and a main memory 503 and a hard disk drive (HDD) 505 as storage means. The CPU 501 executes various programs such as an operating system (OS) and application software. The main memory 503 is a storage area for storing various programs and data used in the execution of the programs, etc. The HDD 505 is a storage area for storing input data for various programs and output data from various programs, etc. These components of the computer 50 implement the functions described in, among others, FIG. 2 above.

The computer 50 includes a communication interface (communication I/F) 507 for communication with external devices such as the infrared thermographic camera 40. The programs to be executed by the CPU 501 (e.g., the program for calculating the interface thermal resistance distribution described above) may be stored in the main memory 503 in advance, may be stored in a storage medium such as a CD-ROM and provided to the CPU 501, or may be provided to the CPU 501 via a network (not shown).

### <Configuration of Measurement Sample 100>

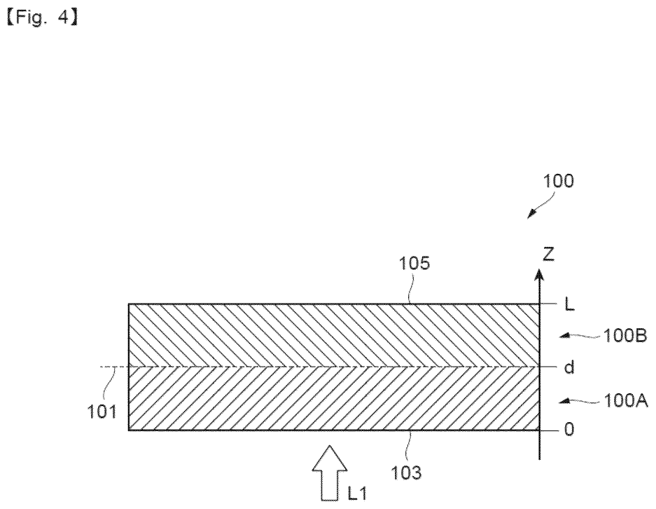

FIG. 4 illustrates a configuration of the measurement sample 100.

Referring now to FIG. 4, a configuration of the measurement sample 100 will be described.

As shown in FIG. 4, the measurement sample 100 is a planar member. The measurement sample 100 is formed of lamination of a first layer (layer A) 100A and a second layer (layer B) 100B, each being a planar member and made of e.g., isotropic graphite. In the measurement sample 100, the first layer 100A and the second layer 100B are in contact with each other via an interface (contact interface) 101.

The first layer 100A and the second layer 100B may be secured to each other by any well-known technique such as adhesive or heat fusion, or may be supported by being sandwiched by a holder (not shown) or the like without being secured to each other. The first layer 100A and the second layer 100B in the illustrated example have the same thickness, each having a thickness d. The thickness d of the first layer 100A and the second layer 100B can be viewed as a dimension of the first layer 100A and the second layer 100B along the heating axis. Although the first layer 100A and the second layer 100B are described as having the same thickness d, they may have different thicknesses.

The measurement sample 100 includes a first surface 103 and a second surface 105, where the first surface 103 is a surface to be irradiated with the laser light from the diode laser 10 (see L1 in the figure), i.e., the surface of the first layer 100A, and the second surface 105 is a surface opposite the surface to be irradiated with the laser light, i.e., the surface of the second layer 100B. The second surface 105 faces the infrared thermographic camera 40. To further illustrate, the infrared thermographic camera 40 measures the thermal distribution on the second surface 105 of the measurement sample 100.

### <Configuration of Support 30>

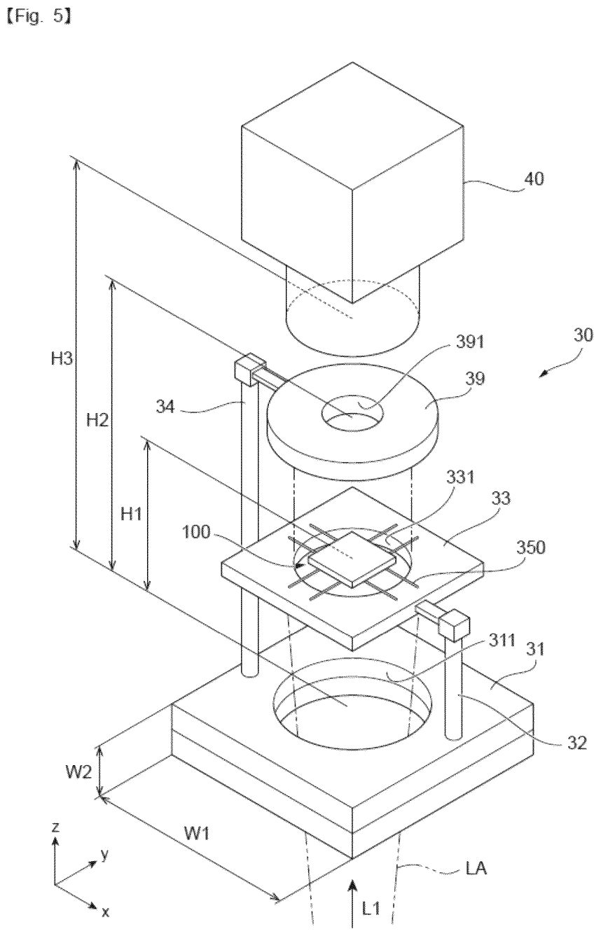

FIG. 5 illustrates a configuration of the support 30.

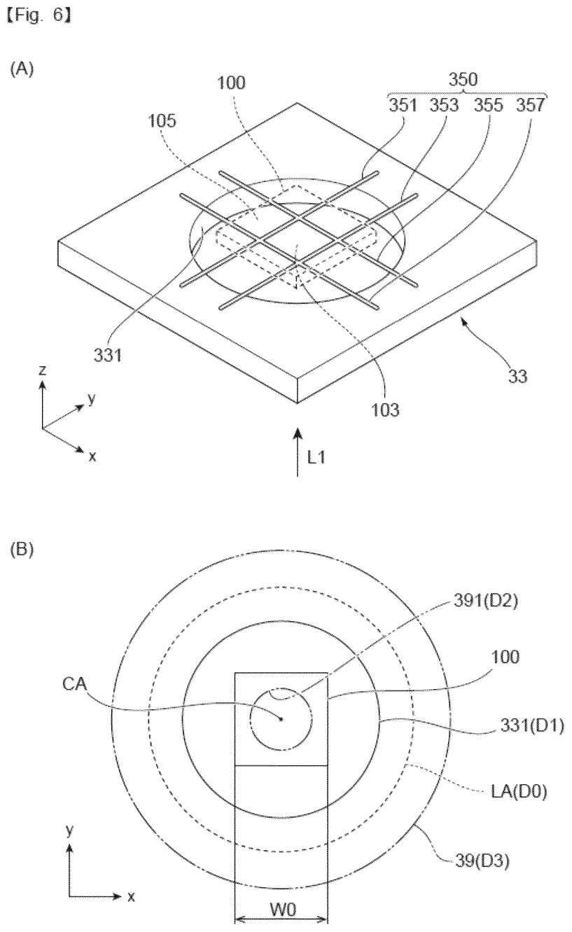

FIG. 6(A) illustrates a configuration of a second stage 33, and FIG. 6(B) illustrates relationship between the laser light LA and the measurement sample 100.

Referring now to FIGS. 5 and 6, a configuration of the support 30 for supporting the measurement sample 100 will be described.

As shown in FIG. 5, the support 30 includes a first stage 31 serving as a base, a first rod 32 and a second rod 34 provided on the first stage 31, a second stage 33 provided to the first rod 32 to support the measurement sample 100, and a diaphragm 39 provided to the second rod 34 to define the region of the measurement sample 100 to be observed by the infrared thermographic camera 40.

The first stage 31 is a so-called x-y stage composed of a generally plate-like member. The first stage 31 in the illustrated example is displaceable in the x- and y-directions. The first stage 31 includes a first opening 311 formed in the center of the plate surface. This first opening 311 is generally circular and allows the laser light LA from the diode laser 10 to pass therethrough. For example, the first stage 31 is 120 mm long in the x- and y-directions (see width W1 in the figure) and 40 mm long in the z-direction (see width W2 in the figure), with the inner diameter of the first opening 311 being 60 mm.

The second stage 33 is a so-called biaxial rotation stage (roll-pitch stage) composed of a generally plate-like member. The second stage 33 shown in the figure can have variable angles in roll and pitch directions. The second stage 33 includes a second opening 331 formed in the center of the plate surface.

As shown in FIG. 6(A), the second stage 33 includes support wires 350 provided across the second opening 331. The support wires 350 are support members for supporting the measurement sample 100. The support wires 350 in the illustrated example include a first wire 351, a second wire 353, a third wire 255, and a fourth wire 357 (which may be referred to hereinafter as the first wire 351, etc.), each being made of 70 μm diameter stainless steel. To further illustrate, the pair of the first and second wires 351, 353 and the pair of the third and fourth wires 355, 357 are disposed across each other above the second opening 331.

The fact that the first wire 351, etc. support the measurement sample 100 on the first surface 103 and the second surface 105 is not in contact with or covered by any other member may improve the accuracy of measurement of the second surface 105 of the measurement sample 100 by the infrared thermographic camera 40. In addition, reducing the diameter of the first wire 351, etc. reduces the possibility of the laser light LA being blocked by the first wire 351, etc.

As shown in FIG. 5, the diaphragm 39 is a so-called iris diaphragm formed of a generally disk-like member. With a well-known configuration, the diaphragm 39 can vary the size of a third opening 391 formed in the center of the plate surface while maintaining the outer diameter of the diaphragm 39. The third opening 391 defines the region of the measurement sample 100, more specifically the region of the second surface 105, to be measured by the infrared thermographic camera 40.

The positions of the components of the support 30 will now be described. Referring to FIG. 5, the positions in the z-direction will first be described. In the z-direction, the first stage 31, the second stage 33, the diaphragm 39, and the infrared thermographic camera 40 are arranged in this order. In a non-limiting example, in the z-direction, the length H1 between the first stage 31 and the second stage 33 may be 42 mm, the length H2 between the first stage 31 and the diaphragm 39 may be 90 mm, and the length H3 between the first stage 31 and the infrared thermographic camera 40 may be 120 mm.

The length of the first rod 32 may be varied to vary the length H1 between the first stage 31 and the second stage 33 in the z-direction. Also, the length of the second rod 34 may be varied to vary the length between the first stage 31 and the diaphragm 39 in the z-direction.

The propagation distance of the laser light is adjusted by varying the length H1 between the first stage 31 and the second stage 33 in the z-direction. This results in varying the outer diameter DO of the laser light LA (see FIG. 6(B) below). In other words, the first rod 32 has the function of adjusting the outer diameter DO of the laser light LA. To further illustrate, the first rod 32 can be viewed as a component to cause the condenser 23 and the measurement sample 100 to move relative to each other. Along with this relative movement of the condenser 23 and the measurement sample 100, the outer diameter DO of the laser light LA emitted to the measurement sample 100 is varied.

The spaced apart relationship between the measurement sample 100, which is supported by the second stage 33, and the diaphragm 39 can prevent the laser light reflected on the surface of the diaphragm 39 from affecting the heating of the measurement sample 100.

A portion of the laser light that did not impinge on the measurement sample 100, i.e., that was not intercepted by the measurement sample 100 may enter the infrared thermographic camera 40. This incident laser light can cause a failure of the infrared thermographic camera 40. Hence, the diaphragm 39 blocks the laser light from entering the infrared thermographic camera 40. To further illustrate, the diaphragm 39 blocks the laser light from going to the infrared thermographic camera 40 while allowing some of the infrared light from the measurement sample 100 to pass therethrough for detection.

Referring now to FIG. 6(B), the positions of the components in the xy-plane will be described. As shown in FIG. 6(B), the laser light LA, the second opening 331 of the second stage 33, the diaphragm 39, and the third opening 391 of the diaphragm 39 are arranged such that their centers are aligned (see center CA). The laser light LA (outer diameter DO) is larger than the second opening 331 (inner diameter D1) of the second stage 33. Accordingly, the laser light LA passes through the entire second opening 331. The measurement sample 100 is smaller than the second opening 331 (inner diameter D1) of the second stage 33. To further illustrate, the measurement sample 100 is disposed within the second opening 331 in the xy-plane. This results in the entire sample 100 being irradiated with the laser light LA passing through the second opening 331.

The third opening 391 (inner diameter D2) of the diaphragm 39 is smaller than the measurement sample 100. As described above, the third opening 391 defines the region of the measurement sample 100 to be measured by the infrared thermographic camera 40. In other words, in the illustrated example, a partial region of the measurement sample 100 is measured by the infrared thermographic camera 40. To further illustrate, the infrared thermographic camera 40 measures the temperature distribution at the center of the second surface 105 of the measurement sample 100 with the exclusion of its edges. This allows for more accurate calculation of interface thermal resistance and thermal diffusivity.

The third opening 391 (inner diameter D2) of the diaphragm 39 is smaller than the second opening 331 (inner diameter D1) of the second stage 33. In other words, the observation region is smaller than the irradiation region. The diaphragm 39 (outer diameter D3) is larger than the second opening 331 (inner diameter D1) of the second stage 33. This prevents some of the laser light LA from entering the infrared thermographic camera 40 as stray light.

The laser light emitted from the diode laser 10 is generally circular in cross section with a diameter of e.g., 0.1 μm to 1 mm. The outer diameter DO of the laser light LA at the second stage 33 is e.g., 30 mm. In this example, the inner diameter D1 of the second opening 331 of the second stage 33 is 27 mm, the inner diameter D2 of the third opening 391 of the diaphragm 39 is 8 mm, the outer diameter D3 of the diaphragm 39 is 50 mm, and the width W0 of the measurement sample 100 is 10 mm. Making the outer diameter DO of the laser light LA, i.e., the irradiation diameter, larger than the size of the measurement sample 100 in this manner can create a one-dimensional through-plane heat flow in the measurement sample 100.

### <Interface Thermal Resistance>

The interface thermal resistance to be measured in the present embodiment will now be described.

The interface thermal resistance is a phenomenon in which heat flow is impeded at a contact interface between substances, resulting in a discontinuous change in temperature. The interface thermal resistance is a bottleneck for heat removal in semiconductor devices such as power modules, which are generating more and more heat along with higher-density packaging, and can cause problems such as failures and performance degradation.

Understanding the thermal resistance mechanism is essential to reduce the thermal resistance. However, a heat transport phenomenon occurs at actual contact interfaces, where thermal resistance factors including physical, mechanical, and geometric properties, such as thermophysical properties, surface roughness, and contact pressure of materials, are affecting one another in a complex manner. And the mechanism of such a heat transport phenomenon has not been clarified. One reason for this is the fact that there is no method to measure a distribution of interface thermal resistance to analyze the influence of a local distribution of thermal resistance factors on the thermal resistance. To further illustrate, conventional methods only calculate an average value of the contact interface thermal resistance over the entire plane, and do not calculate a distribution of the interface thermal resistance.

### <Measurement Principle>

Referring now to FIG. 4, the principle of measuring the interface thermal resistance distribution according to the present embodiment will be described. Here, we consider a one-dimensional heat conduction in a through-plane direction (z-direction) of the measurement sample 100, which is assumed to be a planar laminate material of finite size, when the surface of the measurement sample 100 is uniformly heated.

The governing equation is a one-dimensional heat conduction equation in each of the first layer (layer A) 100A and the second layer (layer B) 100B, which is expressed by Equation (1).

$$\begin{matrix}[ Equation 1 ] & \\ \frac{\partial {T}_{j} ( t , z )}{\partial t} = {D}_{j} \frac{{\partial }^{2} {T}_{j} ( t , z )}{\partial {z}^{2}} & ( 1 )\end{matrix}$$

Where T represents the temperature, t represents the time, D represents the thermal diffusivity, z represents the through-plane (z-direction) distance, and j=A, B represents each layer. When considering periodic heat input at the surface of the first layer 100A, or the first surface 103, and heat insulation at the surface of the second layer 100B, or the second surface 105, the boundary condition is expressed by Equation (2).

$$\begin{matrix}[ Equation 2 ] & \\ \{ \begin{matrix}{λ}_{A} \frac{\partial {T}_{A}}{\partial z} {\vert}_{z = 0} & = - {Q}_{0} {e}^{i ω t} \\ \frac{\partial {T}_{B}}{\partial z} {\vert}_{z = L} & = 0\end{matrix} & ( 2 )\end{matrix}$$

Where λ represents the thermal conductivity, Q₀ represents the heat input constant, and ω represents the angular frequency of periodic heating. Added to this are the heat flux continuity at the contact interface and the thermal interface condition of temperature differences caused by interface thermal resistance, resulting in Equation (3).

$$\begin{matrix}[ Equation 3 ] & \\ \{ \begin{matrix}{λ}_{A} \frac{\partial {T}_{A}}{\partial z} {\vert}_{z = d} & = {λ}_{B} \frac{\partial {T}_{B}}{\partial z} {\vert}_{z = d} \\ - R {λ}_{A} \frac{\partial {T}_{A}}{\partial z} {\vert}_{z = d} & = {T}_{A} ( t , d ) - {T}_{B} ( t , d )\end{matrix} & ( 3 )\end{matrix}$$

Where R represents the interface thermal resistance. These four conditions are used to solve the governing equation. For each of Equations (1) through (3), applying the Laplace transform yields Equations (4) through (6).

$$\begin{matrix}[ Equation 4 ] & \\ s {\hat{T}}_{j} ( s , z ) = {D}_{j} \frac{{\partial }^{2} {\hat{T}}_{j} ( s , z )}{\partial {z}^{2}} & ( 4 )\end{matrix}$$

$$\begin{matrix}[ Equation 5 ] & \\ \{ \begin{matrix}{λ}_{A} \frac{\partial {\hat{T}}_{A}}{\partial z} {\vert}_{z = 0} & = - \frac{{Q}_{0}}{s - i ω} \\ \frac{\partial {\hat{T}}_{B}}{\partial z} {\vert}_{z = L} & = 0\end{matrix} & ( 5 )\end{matrix}$$

$$\begin{matrix}[ Equation 6 ] & \\ \{ \begin{matrix}{λ}_{A} \frac{\partial {\hat{T}}_{A}}{\partial z} {\vert}_{z = d} & = {λ}_{B} \frac{\partial {\hat{T}}_{B}}{\partial z} {\vert}_{z = d} \\ - R {λ}_{A} \frac{\partial {\hat{T}}_{A}}{\partial z} {\vert}_{z = d} & = {\hat{T}}_{A} ( t , d ) - {\hat{T}}_{B} ( t , d )\end{matrix} & ( 6 )\end{matrix}$$

Where s represents the Laplace variable, and T represents the temperature in the Laplace space. The initial condition is set to zero. Equation (4), or the governing equation, is a simple second-order differential equation, and the general solutions are Equations (7) and (8).

$$\begin{matrix}[ Equation 7 ] & \\ {\hat{T}}_{j} ( s , z ) = {U}_{j} exp ( {σ}_{j} z ) + {V}_{j} exp ( - {σ}_{j} z ) & ( 7 )\end{matrix}$$

$$\begin{matrix}[ Equation 8 ] & \\ {σ}_{j} = \sqrt{s / {D}_{j}} & ( 8 )\end{matrix}$$

The coefficients of the general solution equation (7) are solved using Equation (5), or the boundary condition equation, and Equation (6), or the thermal interface condition equation, and applying the inverse Laplace transformation yields Equations (9) through (12).

$$\begin{matrix}[ Equation 9 ] & \\ {U}_{A} = - \frac{{Q}_{0} exp ( - {σ}_{A} d ) H}{2 {λ}_{A} {σ}_{A} G} & ( 9 )\end{matrix}$$

$$\begin{matrix}[ Equation 10 ] & \\ {V}_{A} = {U}_{A} + \frac{{Q}_{0}}{{λ}_{A} {σ}_{A}} & ( 10 )\end{matrix}$$

$$\begin{matrix}[ Equation 11 ] & \\ {U}_{B} = \frac{{Q}_{0} exp ( - {σ}_{B} L )}{2 G} & ( 11 )\end{matrix}$$

$$\begin{matrix}[ Equation 12 ] & \\ {V}_{B} = {U}_{B} exp ( 2 {σ}_{B} L ) & ( 12 )\end{matrix}$$

Where the following equations are met:

$$\begin{matrix}[ Equation 13 ] & \\ H = {λ}_{B} {σ}_{B} sinh [ {σ}_{B} ( L - d ) ] \cdot ( 1 - R {λ}_{A} {σ}_{A} ) - {λ}_{A} {σ}_{A} cosh [ {σ}_{B} ( L - d ) ] & ( 13 )\end{matrix}$$

$$\begin{matrix}[ Equation 14 ] & \\ G = {λ}_{B} {σ}_{B} sinh [ {σ}_{B} ( L - d ) ] \cdot ( cosh [ {σ}_{A} d ] + R {λ}_{A} {σ}_{A} sinh ( {σ}_{A} d ) ) + {λ}_{A} {σ}_{A} cosh [ {σ}_{B} ( L - d ) ] sinh ( {σ}_{A} d ) & ( 14 )\end{matrix}$$

The temperature response of the layers A and B is obtained by Equation (15).

$$\begin{matrix}[ Equation 15 ] & \\ {T}_{j} ( t , z ) = {[ {U}_{j} exp ( {σ}_{j} z ) + {V}_{j} exp ( - {σ}_{j} z ) ]}_{s = i ω} \cdot {e}^{i ω t} & ( 15 )\end{matrix}$$

With L substituted for z for the temperature response of the layer B in Equation (13), the amplitude and phase lag at the back side of the sample are expressed by Equations (16) and (17).

$$\begin{matrix}[ Equation 16 ] & \\ Amp {.}_{j} = \vert {[ {U}_{B} exp ( σ L ) + {V}_{B} exp ( - σ L ) ]}_{s = i ω} \vert & ( 16 )\end{matrix}$$

$$\begin{matrix}[ Equation 17 ] & \\ {Phase}_{j} = arg ( {[ {U}_{B} exp ( σ L ) + {V}_{B} exp ( - σ L ) ]}_{s = i ω} ) & ( 17 )\end{matrix}$$

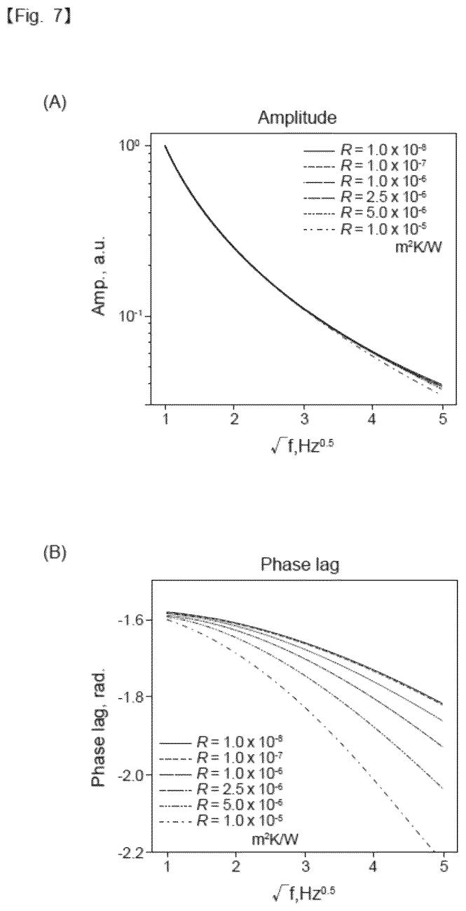

FIG. 7 illustrates the principle of measuring the interface thermal resistance according to the present embodiment. Specifically, FIG. 7(A) illustrates the dependence of the amplitude on the interface thermal resistance in the frequency domain. FIG. 7(B) illustrates the dependence of the phase lag on the interface thermal resistance in the frequency domain. FIGS. 7(A) and 7(B) respectively illustrate theoretical curves of the amplitude and the phase lag with the interface thermal resistance varied from 1.0×10⁻⁸ to 1.0×10⁻⁶ m²K/W.

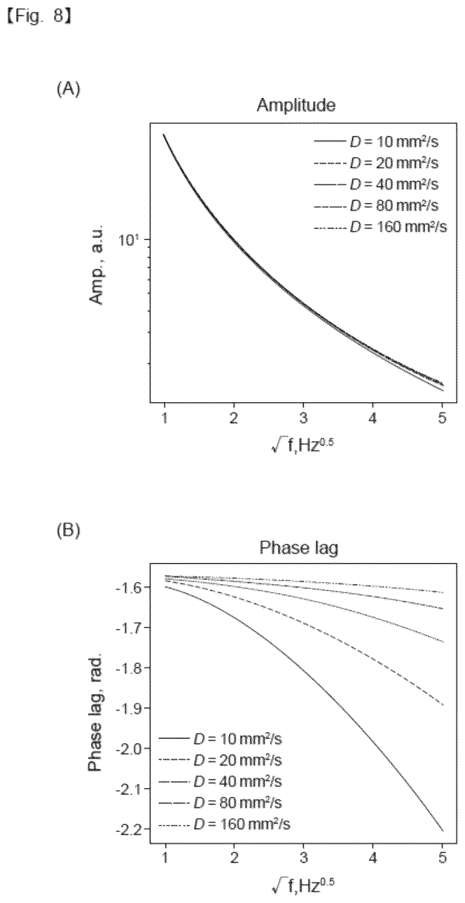

FIG. 8 illustrates the principle of measuring the thermal diffusivity according to the present embodiment. Specifically, FIG. 8(A) illustrates the dependence of the amplitude on the thermal diffusivity in the frequency domain. FIG. 8(B) illustrates the dependence of the phase lag on the thermal diffusivity in the frequency domain. FIGS. 8(A) and 8(B) respectively illustrate theoretical curves of the amplitude and the phase lag with the thermal diffusivity varied from 10 to 160 mm²/s.

Referring now to FIGS. 7 and 8, the analysis of the interface thermal resistance and thermal diffusivity as measured according to the present embodiment will be described in detail. According to the present embodiment, the measurement is performed while varying the heating frequency to analyze changes in the amplitude and phase lag in the frequency domain.

As shown in FIGS. 7 and 8, the amplitude and the phase lag vary depending on different interface thermal resistances and thermal diffusivities. To further illustrate, the behavior of the phase lag, in particular, greatly varies depending on different interface thermal resistances and thermal diffusivities. In the present embodiment, the interface thermal resistance of interest is relatively small (e.g., 1.0×10⁻⁸ to 1.0×10⁻⁶ m²K/W) and samples to be treated are planar and thermally thin, so that the changes in amplitude behavior are small and less sensitive to the thermal diffusivity and interface thermal resistance. Hence, in the present embodiment, the phase lag is analyzed. Along with or instead of the phase lag, the amplitude may also be analyzed.

Based on the above theory and by entering the sample thickness (substituting L for z in Equation (15)), the interface thermal resistance is used as a parameter by entering the thermal diffusivity in Equation (8) when the thermal diffusivity is known (see FIG. 7), or for monolayer samples where the thermal diffusivity is unknown, the thermal diffusivity is used as a parameter by entering R=0 in Equations (13) and (14) (see FIG. 8). In this manner, the theoretical curve is fitted to the phase lag in the frequency domain obtained by the infrared thermographic camera 40 to analyze the interface thermal resistance and the thermal diffusivity.

In the present embodiment, a uniform-intensity heating method is employed, which is capable of generating a one-dimensional heat flow in the through-plane direction of the measurement sample 100. By leveraging the fact that the use of this method, in combination with the non-contact lock-in infrared measurement with the infrared thermographic camera 40, can obtain the information inside the measurement sample 100 as a distribution, the interface thermal resistance of the measurement sample 100 and the thermal diffusivity necessary for that measurement are measured as a distribution.

To further illustrate, in the present embodiment, the infrared thermographic camera 40 is used to measure information about the interface thermal resistance from the surface of the measurement sample 100 as a phase lag distribution. This measurement is performed for multiple heating frequencies, and the dependence of the phase lag distribution on the heating frequencies is analyzed to determine the interface thermal resistance distribution. For a measurement sample 100 that is made of a single material with no contact interface, the thermal diffusivity distribution can be obtained by the same method. In the present embodiment, the thermal resistance is measured based on the observed dynamic heat propagation at the interface using the infrared thermographic camera 40, rather than based on the heat flow rate and temperature. In addition, in the present embodiment, the interface thermal resistance is spatially resolved to evaluate the contribution of thermal resistance elements.

In the present embodiment, points on the entire measurement region of the measurement sample 100 are simultaneously and periodically heated to calculate the through-plane thermal diffusivity at each point, thereby calculating the through-plane thermal diffusivity distribution. Also, points on the entire measurement region of the measurement sample 100 are simultaneously and periodically heated to calculate the interface thermal resistance at each point. In this way, the measurement sample 100 is evaluated by calculating the through-plane thermal diffusivity distribution and/or interface thermal resistance. The simultaneous measurement of multiple points on the measurement sample 100 allows for reducing the measurement time and simplifying the equipment.

### <Operation>

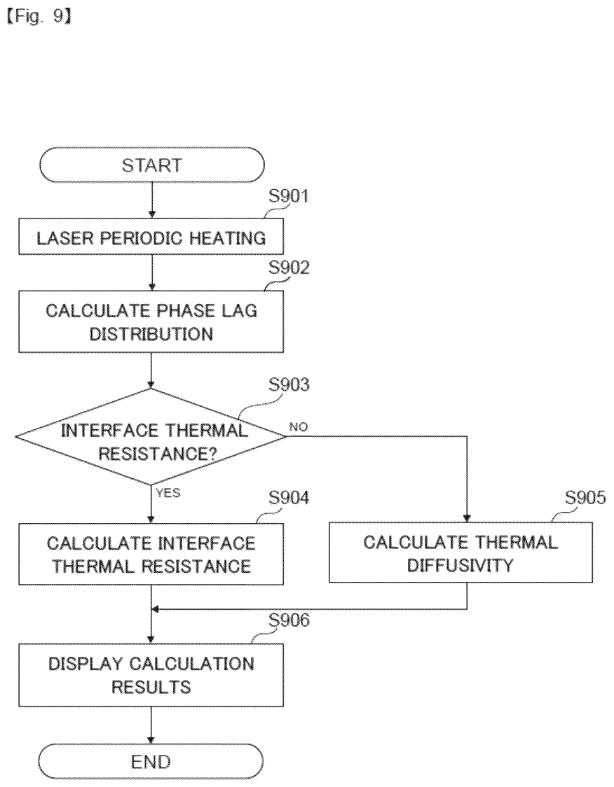

FIG. 9 is a flowchart of an operation of the interface thermal resistance measurement device 1 (see FIG. 1).

Referring now to FIGS. 1 and 9, an operation of the interface thermal resistance measurement device 1 according to the present embodiment will be described. It is hereinafter assumed that a user of the interface thermal resistance measurement device 1, for example, specifies in advance which of the interface thermal resistance and the thermal diffusivity is to be calculated.

First, the surface of the measurement sample 100 is periodically heated by the laser light emitted from the diode laser 10 of the interface thermal resistance measurement device 1 (S901). Then, the phase lag distribution calculating unit 52 measures a phase lag distribution based on the temperature distribution measured by the infrared thermographic camera 40 (S902).

The interface thermal resistance calculating unit 54 then determines whether the interface thermal resistance is to be calculated (S903). If the interface thermal resistance is to be calculated (YES in S903), the interface thermal resistance calculating unit 54 calculates the interface thermal resistance based on the measured phase lag distribution (S904). On the other hand, if the interface thermal resistance is not to be calculated (NO in S903), the thermal diffusivity distribution calculating unit 53 calculates the through-plane thermal diffusivity distribution based on the measured phase lag distribution (S905). Then, the calculation result displaying unit 55 displays the calculation results on a display means (not shown) such as a liquid crystal display (S906).

### <Measurement Results 1>

FIG. 10 illustrates first measurement results. More specifically, FIG. 10(A) illustrates a configuration of a first sample 200, which is an example of the measurement sample 100, and FIG. 10(B) illustrates the interface thermal resistance distribution measured by the interface thermal resistance measurement device 1.

Referring now to FIG. 10, the first measurement results using the first sample 200 will be described.

As shown in FIG. 10(A), the first sample 200 is composed of lamination of a first layer 201 and a second layer 203. The first layer 201 and the second layer 203 are each 0.5 mm thick and made of IG-110. Generally crisscrossing grooves 205, 207 are formed in a surface 204 of the second layer 203 facing the first layer 201. The groove width of the grooves 205, 207 is 0.4 mm to 0.5 mm. The groove depth of the grooves 205, 207 is 0.4 mm to 0.5 mm.

The first layer 201 and the second layer 203 are bonded with an epoxy-based adhesive. The interior of the grooves 205, 207 is filled with the adhesive. The region where the grooves 205, 207 are formed has a larger interface thermal resistance at the contact interface of the first sample 200.

As shown in FIG. 10(B), cross lines are visualized in the interface thermal resistance distribution obtained by the interface thermal resistance measurement device 1 (see regions A1, A2 in the figure). These cross lines correspond to the region where the grooves 205, 207 are formed. This demonstrates that the difference in interface thermal resistance can be detected even at the contact interface where the interface thermal resistance is relatively small (in the order of 1×10⁻⁶ m²K/W) due to the adhesive state.

### <Measurement Results 2>

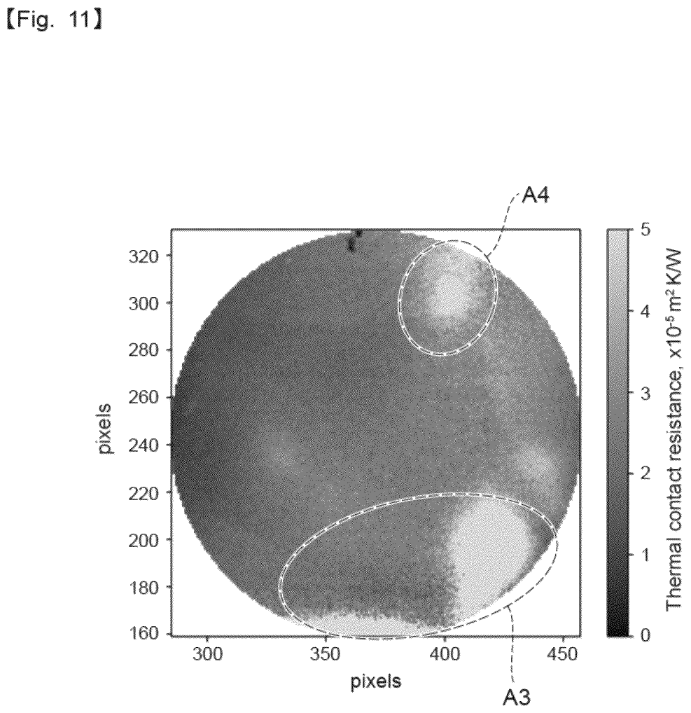

FIG. 11 illustrates second measurement results. More specifically, FIG. 11 illustrates an interface thermal resistance distribution in an aluminum alloy laminate (not shown) as the measurement sample 100, as measured by the interface thermal resistance measurement device 1.

Referring now to FIG. 11, the second measurement results are shown. In this measurement, a laminate of aluminum alloys (more specifically, A5052) each being 0.38 mm thick was used as the measurement sample 100. The aluminum alloys were bonded at the contact interface with a silicon-based grease. This silicon-based grease is a common adhesive used in personal computers, for example.

As shown in FIG. 11, regions with higher thermal resistance are present in the interface thermal resistance distribution obtained by the interface thermal resistance measurement device 1. More specifically, regions with higher thermal resistance can be observed in a lower portion (see region A3 in the figure) and an upper portion (see region A4 in the figure) of the distribution diagram in FIG. 11. This demonstrates that the interface thermal resistance measurement device 1 can visualize the presence of high thermal resistance spots that cannot be predicted from the sample appearance or temperature images.

### <Measurement Results 3>

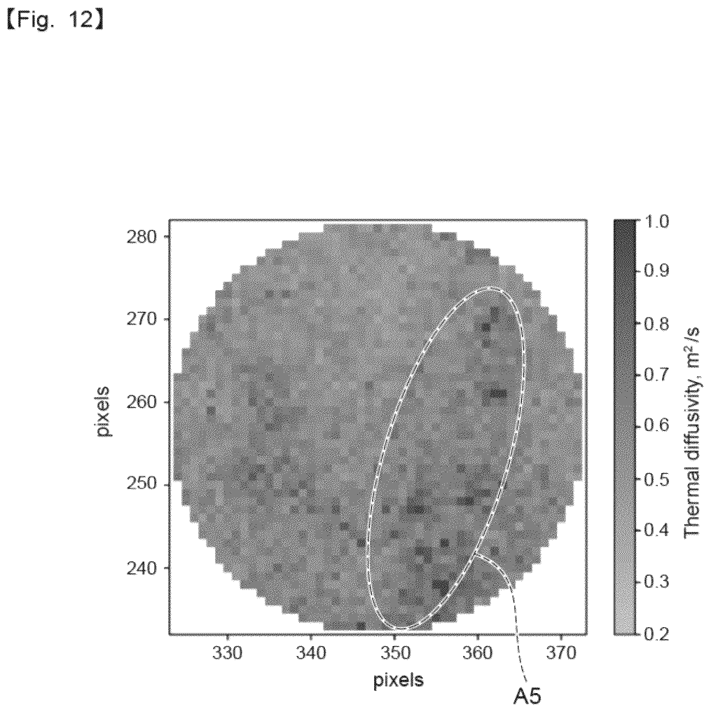

FIG. 12 illustrates third measurement results. More specifically, FIG. 12 illustrates an example measurement of the through-plane thermal diffusivity in a monolayer composite material as the measurement sample 100, as measured by the interface thermal resistance measurement device 1.

Referring now to FIG. 12, the third measurement results are shown. In this measurement, a 0.5 mm thick, carbonaceous rock was used as the measurement sample 100.

FIG. 12 shows that there are variations in the through-plane thermal diffusivity in the through-plane thermal diffusivity distribution obtained by the interface thermal resistance measurement device 1. More specifically, a region with a higher through-plane thermal diffusivity can be observed on the right side (see region A5 in the figure) of the distribution diagram in FIG. 12. This demonstrates that the interface thermal resistance measurement device 1 can detect differences in through-plane thermal diffusivity in cases where, for example, a filler is unevenly dispersed in a composite material.

For example, to reduce the contact interface thermal resistance between a heat generating part and a heat dissipating element such as a heat sink, a high thermal conductivity grease or thermal interface material (TEM material) is used to fill the gap between the two components. The thermal interface material is generally a composite material consisting of high thermal conductivity particles as a filler and rubber or resin as a matrix, and in order to achieve both cost and performance, it is necessary to evenly disperse the filler in a small amount. However, there has been no method to measure the degree of filler dispersion in composite materials as well as the thermal conductivity at each location. On the other hand, the interface thermal resistance measurement device 1 can obtain a distribution of the thermal diffusivity as the information about the interior of the sample, as described above.

### <Three-Layer Structure>

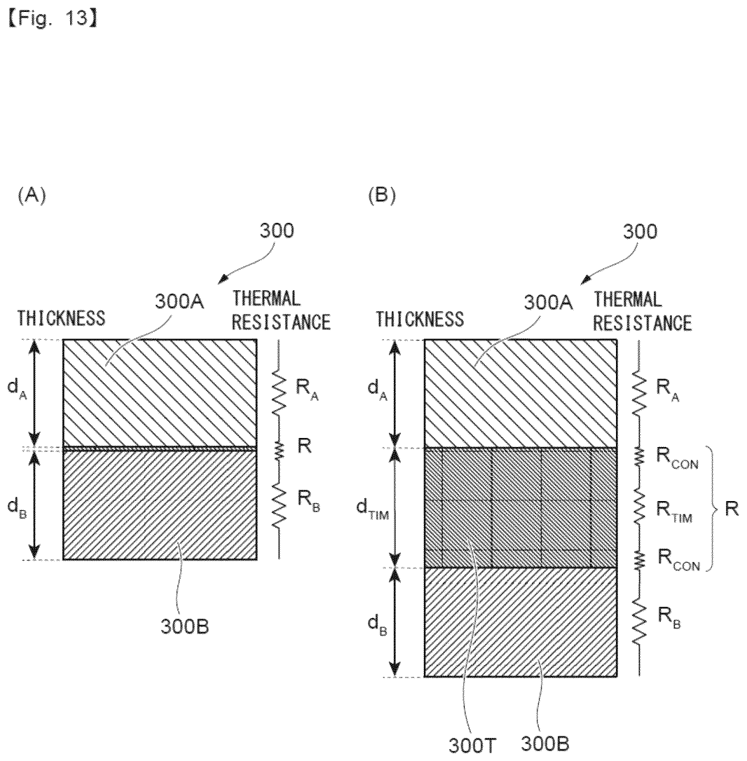

FIG. 13 illustrates the principle of measuring interface thermal resistance of a measurement sample 300 with three layers.

Referring now to FIG. 13, the principle of measuring interface thermal resistance in a measurement sample 300 with three layers will be described.

In the above description, the measurement sample 300 has been described as having a first layer (layer A) 300A and a second layer (layer B) 300B, as shown in FIG. 13(A). The thermal resistance at the contact interface between the first layer 300A and the second layer 300B has been described as the interface thermal resistance R. The first layer 300A and the second layer 300B have a thickness da and a thickness de, respectively. The first layer 300A and the second layer 300B have a thermal conductivity λ_{A} and a thermal conductivity λ_{B}, respectively. Further, the first layer 300A and the second layer 300B have a thermal resistance RA and a thermal resistance RB, respectively.

As shown in FIG. 13(B), the measurement sample 300 can be viewed as having an adhesive layer 400T at the interface between the first layer 300A and the second layer 300B, where the adhesive layer 400T is made of a so-called thermal interface material (TIM material) with a finite thickness d_{TIM}. In other words, the measurement sample 300 has a third layer, or the adhesive layer 400T, between the first layer 300A and the second layer 300B. In this case, the contact interface thermal resistance R measured above is the composite resistance of a thermal resistance R_{TIM} of the adhesive layer 400T, a contact interface thermal resistance R_{CON}, which is the thermal resistance between the first layer 300A and the adhesive layer 400T, and a contact interface thermal resistance R_{CON}, which is the thermal resistance between the second layer 300B and the adhesive layer 400T.

With a given thermal conductivity λ_{TIM} of the adhesive layer 400T, the contact interface thermal resistance R measured above is expressed by Equation (18).

$$\begin{matrix}[ Equation 18 ] & \\ R = {R}_{con} + {R}_{TIM} + {R}_{con} = {R}_{con} + \frac{{d}_{TIM}}{{λ}_{TIM}} + {R}_{c o n} & ( 18 )\end{matrix}$$

From the above, the contact interface thermal resistance R_{CON} is derived from Equation (19).

$$\begin{matrix}[ Equation 19 ] & \\ {R}_{c o n} = ( R - \frac{{d}_{TIM}}{{λ}_{TIM}} ) / 2 & ( 19 )\end{matrix}$$

As described above, the interface thermal resistance measurement device 1 can also measure samples with three or more layers.

### First Variation

In the above description, the diode laser 10 and the light guide 20 are used to heat the measurement sample 100. However, this is not limiting and any other method or arrangement may be used that ensure a uniform intensity distribution on the irradiation plane of the measurement sample 100. For example, an array of multiple light emitting diodes (LEDs) may be used as the light source. Other heating methods that can heat the entire measurement sample 100, such as induction heating or resistance heating, may be used. Further, instead of at least one of the fiber 21 and the condenser 23, or in combination with the fiber 21 and the condenser 23, a diffuser plate, such as so-called frosted glass, may be used to diffuse light from the light source. In addition, a diode laser with a relatively large Gaussian distribution may be used as the diode laser 10. To further illustrate, a portion with a constant light intensity of the laser light with a relatively large Gaussian distribution may be used to homogenize the intensity distribution on the irradiation plane of the measurement sample 100.

In the above description, the first surface 103 of the measurement sample 100 is supported by the first wire 351 etc. However, this is not limiting. For example, the interface thermal resistance measurement device 1 shown in FIG. 1 may be turned upside down such that the second surface 105 of the measurement sample 100, i.e., the observation side of the measurement sample 100, may be supported by the first wire 351 etc. The member to support the measurement sample 100 is not limited to the first wire 351 etc. and may be any other member that has a relatively small contact area with the measurement sample 100. For example, an implementation is possible where the measurement sample 100 is supported by tip ends of multiple rod-like members (needle-like members).

In the above description, the diaphragm 39 is provided between the measurement sample 100 and the infrared thermographic camera 40. However, an implementation without the diaphragm 39 is also possible. Also, while the third opening 391 of the diaphragm 39 has been described as having a variable diameter, an implementation is possible where the diameter is not variable.

In the above description, the value of the interface thermal resistance of the interface 101 is output. However, this is not limiting and any other information about the interface thermal resistance may be output. For example, only the result of comparison with a threshold may be output. To further illustrate, for example, a specific image (e.g., a specific numerical value or symbol) may be displayed in response to obtaining an interface thermal resistance greater than the threshold, and another image (e.g., another specific numerical value or symbol) may be displayed in response to obtaining an interface thermal resistance smaller than the threshold. To further illustrate, a numerical value or the like corresponding to the interface thermal resistance value may be displayed.

The interface thermal resistance varies depending on the state of contact between samples (the first layer 100A and the second layer 100B in the above example). Here, the state of contact between the samples includes, for example, the strength of adhesion between the samples and the amount of pressure by which the samples are pressed against each other. The state of contact between the samples also includes voids or cracks in the interface 101 and the first and second layers 100A. 100B, poor contact, the presence/absence of regions devoid of grease or adhesive placed between the first and second layers 100A, 100B, or the intervention of foreign substances. The interface thermal resistance measurement device 1 described above can be viewed as a device to obtain information about the state of contact between the first and second layers 100A, 100B of the measurement sample 100.

Machine learning may be used to observe changes in the temperature distribution detected by the infrared thermographic camera 40 and update a function that determines the state of contact between samples based on the temperature distribution, and information about the interface thermal resistance may be output based on the obtained function.

In the above description, the calculation result displaying unit 55 displays (outputs) the calculation results of the interface thermal resistance and the thermal diffusivity as the sample evaluation on a display (not shown). However, this is not limiting. For example, other implementations are possible where the calculation results of at least one of the interface thermal resistance and the thermal diffusivity is transmitted to another device than the computer 50 or stored in the computer 50.

Other implementations are also possible where the information about the thermal diffusivity of the measurement sample 100 is output and/or stored together with or instead of the information about the interface thermal resistance. Here, the information about the thermal diffusivity includes the value of the thermal diffusivity, relative evaluation of the thermal diffusivity (e.g., how large or small the thermal diffusivity is), and results of comparison with pre-evaluation data or theoretical values. To further illustrate, in the variation shown in FIG. 12 above, a monolayer composite material is used as the measurement sample 100. In other words, the measurement sample 100 to be measured by the interface thermal resistance measurement device 1 may have either a monolayer configuration or a multilayer configuration.

The measurement sample 100 is not limited. For example, glass, semiconductors, polymer films, liquid crystal, etc. may be used as the measurement sample 100. When glass is used as the measurement sample 100, voids or cracks formed inside the measurement sample 100 can be detected. In other words, information about the density of the measurement sample 100 can be obtained as a sample evaluation of the measurement sample 100. The information about the density refers to information that can be used to determine the density of the measurement sample 100. The information about the density includes, in addition to the value of the density of the measurement sample 100, a relative evaluation of the density (e.g., coarse/dense) and the presence/absence of voids inside the measurement sample 100.

### Variation 2

### (Principle of Fatigue Evaluation)

As described above, the interface thermal resistance measurement device 1 calculates the through-plane thermal diffusivity distribution based on the phase lag distribution (see S905 in FIG. 9). Here, the interface thermal resistance measurement device 1 is capable of obtaining information about fatigue of the measurement sample 100 in a non-contact manner. To further illustrate, the interface thermal resistance measurement device 1 can evaluate a fatigue condition of the measurement sample 100 that may be caused by repeated application of loads to the measurement sample 100 in a tensile test, for example.

Hereinafter, carbon fiber-reinforced composite materials as an example of the measurement sample 100 will first be described, followed by a description of the fatigue properties of carbon fiber-reinforced composite materials and then by a description of the principle of measuring a fatigue condition by the interface thermal resistance measurement device 1.

Carbon fiber-reinforced composite materials, which are an example of the measurement sample 100, are expected to find applications in, for example, transportation and aerospace industries by virtue of their advantages such as high specific strength, corrosion resistance, and fatigue resistance properties. Here, characteristics of carbon fiber-reinforced composite materials associated with fatigue, i.e., fatigue properties, vary greatly depending on the manufacturing quality and operating environment. Therefore, it is required to understand the fatigue properties of carbon fiber-reinforced composite materials. Such understanding of the fatigue properties is expected to, for example, extend the designed lifetime of products.

Repeated application of loads to a carbon fiber-reinforced composite material can cause a crack (fatigue crack) in the carbon fiber-reinforced composite material. As the fatigue crack grows in length, it may lead to delamination or fiber rupture inside the carbon fiber-reinforced composite material, eventually leading to fatigue failure of the entire material. In addition, slight delamination (micro delamination) may occur and grow to cause larger delamination. The origin of such delamination is believed to be stress risers, such as microvoids (tiny voids) inside the material that occur during manufacture, portions where a resin layer is thin due to proximity between fibers, and inter-layer portions. Microcracks and micro delamination are believed to occur and grow from these stress risers, leading to macroscopic fatigue cracks and delamination. By quantifying this process, it may be possible to diagnose the fatigue properties or fatigue condition of the material.

Known methods for detecting the origin of fatigue cracks in carbon fiber-reinforced composite materials and their subsequent growth patterns include image analysis and X-ray CT methods. However, the image analysis method can only extract information about the surface layer of a sample and cannot evaluate the interior of the sample. Meanwhile, X-ray CT, which observes small regions, requires an enormous amount of time to evaluate an entire sample. In addition, X-ray CT requires cutting out samples, so that it is difficult to observe large components using this technique. Hence, the interface thermal resistance measurement device 100 calculates the fatigue condition of the measurement sample 100 by measuring the through-plane thermal diffusivity distribution using non-contact laser heating.

To further illustrate, microcracks and micro delamination in the measurement sample 100 are accompanied by occurrence of a crack interface inside the measurement sample 100. This interface then acts as a thermal resistance, resulting in a local decrease in the effective thermal diffusivity of the measurement sample 100. To further illustrate, for example, the presence of microcracks or micro delamination may be detected by measuring the through-plane thermal diffusivity of the measurement sample 100. In the present embodiment, the changes in thermal diffusivity are utilized to quantify the growth trend of microcracks and micro delamination with the use of laser light, thereby allowing for diagnosis of the fatigue condition of the measurement sample 100. This may allow for quantification of the fatigue condition of the measurement sample 100 in a nondestructive and more extensive manner.

The interface thermal resistance measurement device 1 can, for example, detect the growth trend of microcracks and micro delamination that cannot be visually recognized and thus detect an initial degradation of the measurement sample 100. While the microcracks and micro delamination have been discussed above, material alterations that occur inside the measurement sample 100 are not limited to these. Other material alterations include, for example, lattice defects and bond breaks that occur inside the measurement sample 100. In the present embodiment, changes in thermal diffusivity, which is an example of a thermophysical property value, may be utilized to quantify these material alterations.

### (Fatigue Evaluation Process)

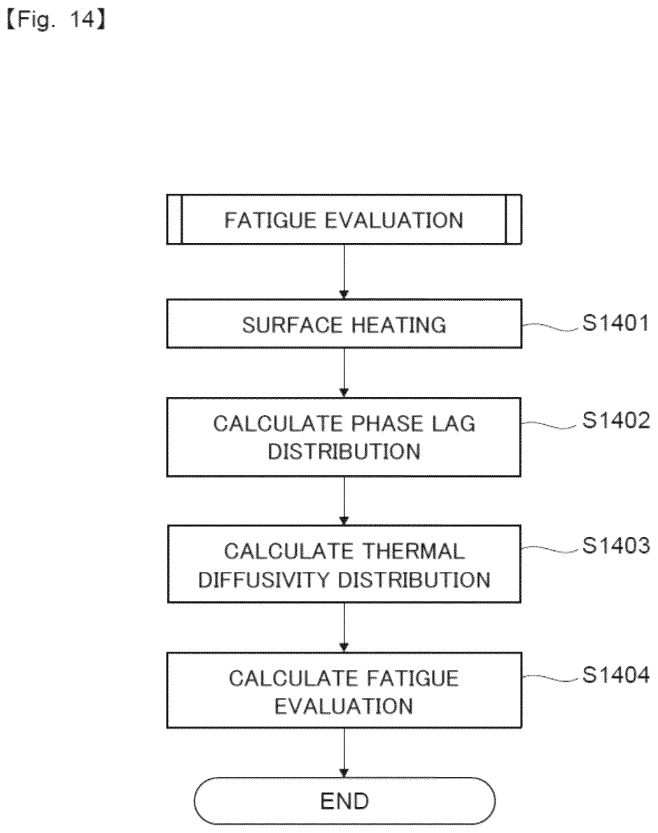

FIG. 14 is a flowchart illustrating a fatigue evaluation process by the interface thermal resistance measurement device 1.

Referring now to FIGS. 1, 2 and 14, a fatigue evaluation process by the interface thermal resistance measurement device 1 will be described.

First, the entire first surface 103 of the measurement sample 100 is periodically heated (surface-heated) by the laser light emitted from the diode laser 10 in the interface thermal resistance measurement device 1 (S1401). The phase lag distribution calculating unit 52 then calculates a phase lag distribution based on the temperature distribution measured by the infrared thermographic camera 40 (S1402).

Based on the phase lag distribution, the thermal diffusivity distribution calculating unit 53 calculates a through-plane thermal diffusivity distribution (S1403). Based on the calculated thermal diffusivity distribution, the thermal diffusivity distribution calculating unit 53 calculates a fatigue evaluation of the measurement sample 100 (S1404).

### (Evaluation Function)

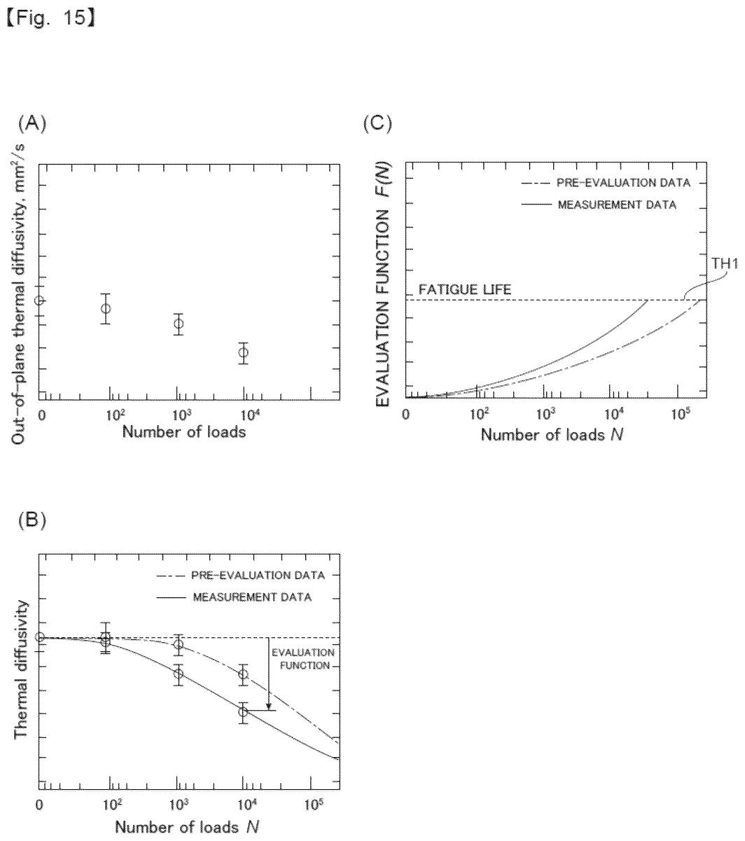

FIG. 15 illustrates changes in fatigue evaluation with respect to a load count (the number of loads applied). FIG. 15(A) illustrates relationship between the through-plane thermal diffusivity and the load count. In the graph of FIG. 15(A), the horizontal axis represents the load count, and the vertical axis represents the thermal diffusivity. The error bars in FIG. 15(A) are the standard deviations in the in-plane distribution. FIG. 15(B) illustrates relationship between the thermal diffusivity and the load count. In the graph of FIG. 15(B), the horizontal axis represents the load count, and the vertical axis represents the thermal diffusivity. FIG. 15(C) illustrates relationship between the evaluation function and the load count. In the graph of FIG. 15(C), the horizontal axis represents the load count, and the vertical axis represents the evaluation function.

Referring now to FIG. 15, changes in fatigue evaluation with respect to a load count will be described. As shown in FIG. 15(A), the thermal diffusivity decreases as the fatigue progresses along with an increase in load count and resultant increase in microcracks and the like. In this example, it is possible to identify portions where fatigue has progressed compared to other portions, based on the amount of decrease in thermal diffusivity distribution at a specific load count from the undamaged condition (N=0). To further illustrate, the greater the decrease in thermal diffusivity, the more the fatigue is considered to have progressed.

Here, the thermal diffusivity distribution calculating unit 53 calculates a fatigue evaluation of the measurement sample 100 as described above (see S1404 in FIG. 14 above). The fatigue evaluation of the measurement sample 100 is determined using, for example, a value (fatigue evaluation value) that is calculated based on an evaluation function F(N) shown in Equation (20).

$$\begin{matrix}[ Equation 20 ] & \\ F ( N ) = D ( 0 ) - D ( N ) & ( 20 )\end{matrix}$$

Where D(N) is the thermal diffusivity as a function of the load count (N), and D(0) is the thermal diffusivity in the undamaged condition. In other words, this evaluation function F(N) evaluates the difference in thermal diffusivity, or more specifically the amount of decrease in thermal diffusivity, as a function of the load count. The larger this evaluation function is, the more the fatigue has progressed, i.e., the more pronounced the fatigue is. Monitoring this evaluation function allows for diagnosing the fatigue condition. In response to the fatigue evaluation value exceeding a predefined value corresponding to fatigue damage, it is determined that the fatigue life has been reached.

As indicated by the measurement data shown in FIG. 15(B), the thermal diffusivity measurement is performed for each predetermined load count, and the difference in thermal diffusivity from the undamaged condition is obtained as an evaluation function. The evaluation function F(N) is plotted as shown in FIG. 15(C). The maximum value of the evaluation function is defined as the thermal diffusivity difference at which delamination or transverse cracks are occurring, and the condition where the maximum value (threshold TH1) has been reached is diagnosed as having reached the fatigue life. As shown in FIG. 15(B), a data plot of thermal diffusivity changes from the fatigue initiation may be obtained in advance, which may allow for evaluation of the fatigue growth rate at the time of measurement with respect to such a prior evaluation.

With pre-obtained evaluation data, the fatigue condition and its growth rate can be evaluated in comparison with actual measurement data. Without any pre-evaluation data, the fatigue condition can still be quantified in comparison with the undamaged condition. In both cases, it is possible to provide a reference in predicting the occurrence of fatigue cracks.

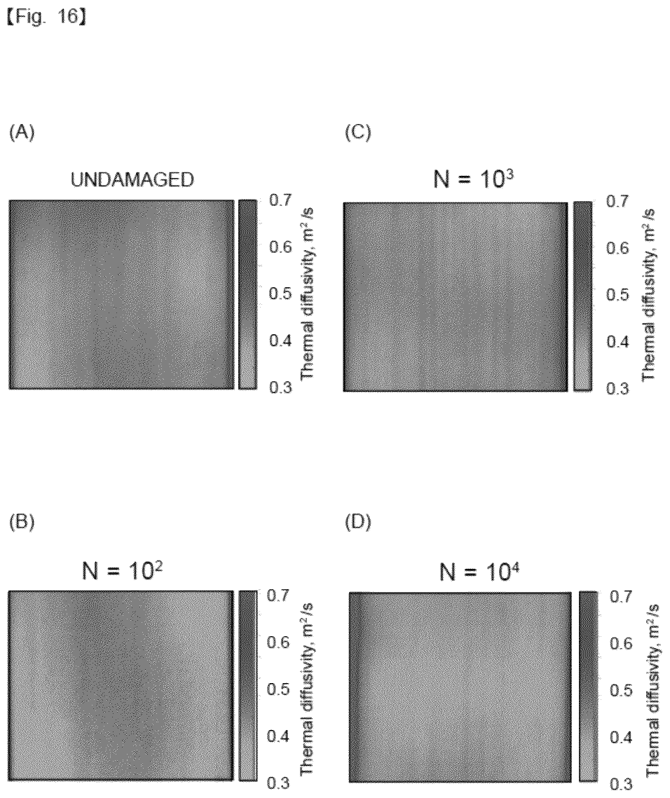

FIG. 16 illustrates the thermal diffusivity distribution for each load count. FIG. 16(A) illustrates the thermal diffusivity distribution in the measurement sample 100 in the undamaged condition (N=0). Similarly, FIG. 16(B) illustrates the thermal diffusivity distribution in the measurement sample 100 at 100 load counts, FIG. 16(C) illustrates the thermal diffusivity distribution in the measurement sample 100 at 1,000 load counts, and FIG. 16(D) illustrates the thermal diffusivity distribution in the measurement sample 100 at 10,000 load counts.

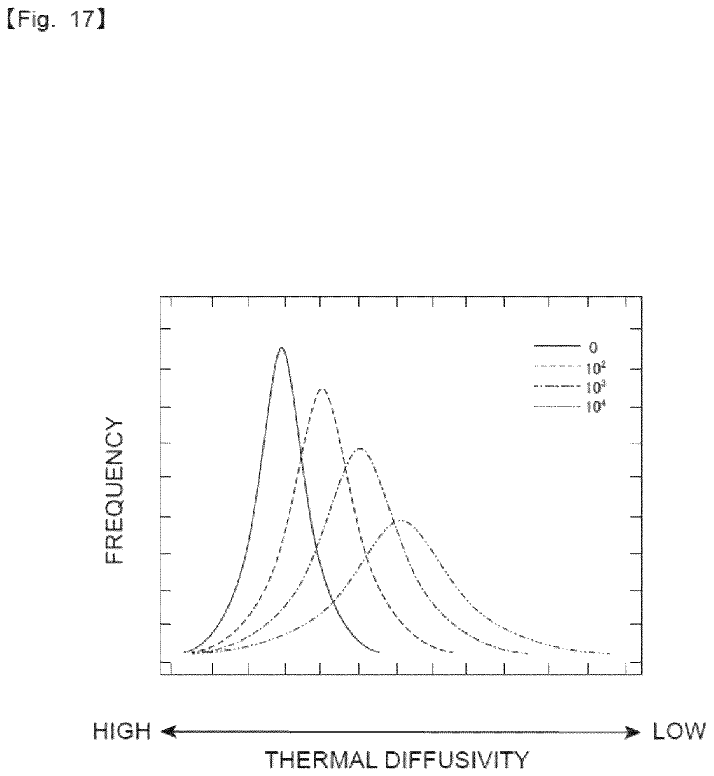

FIG. 17 illustrates changes in the thermal diffusivity distribution with respect to a load count. In the graph of FIG. 17, the horizontal axis represents the thermal diffusivity, and the vertical axis represents the frequency of occurrence (counts). The frequency of occurrence refers to the number of occurrences of pixels representing the thermal diffusivity of interest in images of the thermal diffusivity distribution.

Referring now to FIGS. 16 and 17, changes in the thermal diffusivity distribution with respect to a load count will be described. As shown in FIGS. 16 and 17, more damage occurs inside the measurement sample 100 with an increase in load count, resulting in changes in through-plane thermal diffusivity distribution. To further illustrate, the through-plane thermal diffusivity tends to decrease as the load count increases from the undamaged condition (N=0).

### (Damage Occurrence Prediction)

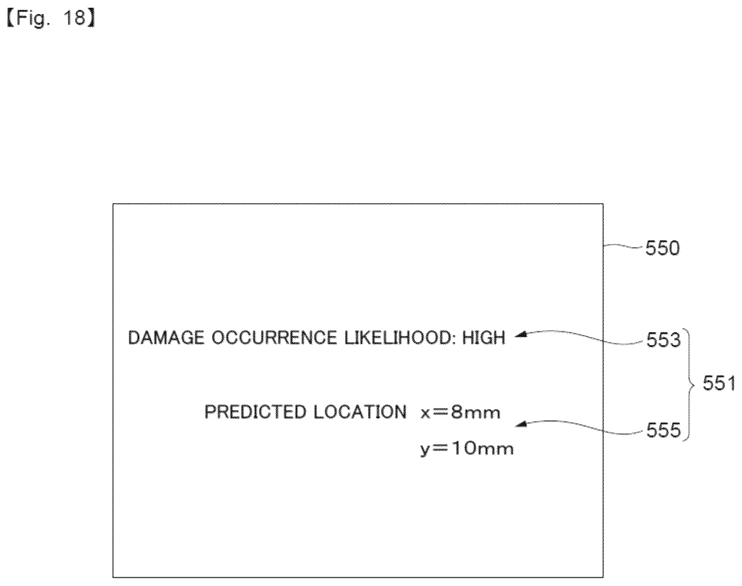

FIG. 18 illustrates a damage occurrence prediction image 551 presented in a display area 550.

Referring now to FIG. 18, an example of damage occurrence prediction performed by the interface thermal resistance measurement device 1 will be described.

First, the interface thermal resistance measurement device 1 detects the occurrence of microcracks, micro delamination, etc. inside the measurement sample 100 based on changes in thermal diffusivity as described above. Such microcracks and micro delamination may give rise to fatigue cracks, for example. Accordingly, the locations where microcracks or micro delamination have occurred can be locations where fatigue cracks or other damages are likely to occur in the measurement sample 100.

Thus, as shown in e.g., FIG. 18, the thermal diffusivity distribution calculating unit 53 detects whether there is a low-thermal diffusivity location(s) in the thermal diffusivity distribution. For example, the thermal diffusivity distribution calculating unit 53 detects a location(s) where the thermal diffusivity is lower than a threshold. In response to detecting a location(s) with thermal diffusivity below the threshold, the calculation result displaying unit 55 presents a damage occurrence prediction image 551 on a display area 550, which is implemented by a display or the like, as shown in FIG. 18. The damage occurrence prediction image 551 includes a likelihood image 553 indicative of the degree of likelihood of damage occurrence. The likelihood of damage occurrence may be evaluated, for example, according to relationship with multiple thresholds. More specifically, the likelihood of damage occurrence may be evaluated as being high if the likelihood is smaller than a first threshold, and the likelihood of damage occurrence may be evaluated as being low if the likelihood is greater than the first threshold and smaller than a second threshold (>the first threshold). The damage occurrence prediction image 551 also includes a location image 555 indicative of information about a location where the likelihood is below the threshold, i.e., where damage is predicted to occur in the measurement sample 100. The damage occurrence prediction image 551 allows for identifying any location in the measurement sample 100 where damage, such as cracks, is likely to occur.

### Variations

In the above description, the fatigue evaluation is performed by measuring the thermal diffusivity of the measurement sample 100. However, the method of fatigue evaluation is not limited to this, and any other evaluation method may be employed provided that it is based on the temperature distribution formed in the measurement sample 100. For example, the fatigue evaluation of the measurement sample 100 may be performed by measuring a distribution of temperature rise in the measurement sample 100 associated with heating the measurement sample 100 for a predetermined period or a distribution of absolute temperature after the heating. The thermal properties (thermophysical properties) of the measurement sample 100, such as the thermal diffusivity, will change as a result of material alterations, such as fatigue cracks, occurring inside the measurement sample 100. Thus, observing the temperature distribution formed in the measurement sample 100 allows for fatigue evaluation of the measurement sample 100.

In the above description, the difference in thermal diffusivity from the reference undamaged condition is used for the fatigue evaluation. However, this is not limiting. For example, a ratio of thermal diffusivity or an absolute value of thermal diffusivity may be used for the fatigue evaluation. Further, instead of or in addition to using the undamaged condition as the reference, fatigue evaluation may be performed based on the condition where the fatigue life has been reached or on prior evaluation data or theoretical values. The information about the fatigue includes, in addition to values calculated as the fatigue evaluation of the measurement sample 100, relative evaluation of fatigue (e.g., how far fatigue has progressed), reaching or not reaching the fatigue life, the estimated duration and number of times the sample can be used before reaching the fatigue life, the presence or absence of microcracks or micro delamination inside the measurement sample 100, etc.

The information about the thermal diffusivity, which is obtained in the process of calculating the information about the fatigue of the measurement sample 100, may be output and/or stored together with or instead of the information about the fatigue. The information about the thermal diffusivity includes the value of thermal diffusivity, relative evaluation of thermal diffusivity (e.g., how large or small the thermal diffusivity is), and results of comparison with prior evaluation data or theoretical values.

Further, information about the life of the measurement sample 100 may be output and/or stored together with or instead of the information about the fatigue of the measurement sample 100. The information about the life includes reaching or not reaching the fatigue life, the estimated duration and number of times the sample can be used before reaching the fatigue life, and the degree (e.g., percentage) of fatigue progress with respect to the fatigue life, etc.

In the above description, the information about the fatigue of the measurement sample 100 associated with a tensile test is obtained. However, this is not limiting. The information about the fatigue of the measurement sample 100 may be obtained from any other load test that applies loads to the measurement sample 100, such as plane bending fatigue tests, rotary bending fatigue tests, and ultrasonic fatigue tests.

The measurement sample 100 is an example of the sample. The diode laser 10 is an example of the light source. The light guide 20 is an example of an irradiating unit. The infrared thermographic camera 40 is an example of the detecting unit. The computer 50 is an example of the identifying unit. The interface thermal resistance measurement device 1 is an example of an interface information identification device and an internal information identification device. The fiber 21 is an example of the multimode fiber. The condenser 23 is an example of the guide body. The first rod 32 is an example of the changing unit. The diaphragm 39 is an example of the opening body. The diode laser 10 and the light guide 20 are an example of the optical heating device.

While various embodiments and variations have been described above, it will be readily understood that these embodiments and variations may be combined.

The present disclosure is not limited in any way to the above embodiments, and may be implemented in various forms without departing from the gist of the present disclosure.

### REFERENCE SIGNS LIST

1 Interface thermal resistance measurement device
10 Diode laser
20 Light guide
21 Fiber
23 Condenser
39 Diaphragm
40 Infrared thermographic camera
50 Computer

1. An interface information identification device comprising:
a light source configured to emit light to heat a planar sample, the sample including a first layer and a second layer overlapping the first layer;
an irradiating unit configured to homogenize an intensity distribution of light from the light source to irradiate an entire surface of the first layer of the sample with the light;
a detecting unit configured to detect, at an opposite side of the sample from the irradiating unit, a temperature distribution on a surface of the second layer of the sample; and
an identifying unit configured to identify information about an interface between the first layer and the second layer of the sample based on the temperature distribution detected by the detecting unit.

2. The interface information identification device according to claim 1, wherein the irradiating unit includes a guide body configured to guide light from the light source toward the sample while spreading the light to make an irradiation area of the light reaching the sample larger than the sample.

3. The interface information identification device according to claim 2, wherein the irradiating unit includes a multimode fiber configured to receive and propagate light from the light source and output the light toward the guide body.

4. The interface information identification device according to claim 2, further comprising a changing unit configured to cause the sample and the guide body to move relative to each other to change a size of the irradiation area of the light reaching the sample.

5. The interface information identification device according to claim 1, further comprising an opening body between the sample and the detecting unit, the opening body including an opening allowing for passage therethrough of infrared rays that go from the surface of the second layer of the sample toward the detecting unit.

6. The interface information identification device according to claim 5, wherein the opening body is larger than the sample and the opening of the opening body is smaller than the sample.

7. The interface information identification device according to claim 1, wherein the detecting unit is configured to detect a temperature distribution at a center of the surface of the second layer of the sample, excluding edges of the surface.

8. The interface information identification device according to claim 1, wherein the information about the interface includes information about an interface thermal resistance.

9. The interface information identification device according to claim 1, further comprising a displaying unit configured to display the information about the interface identified by the identifying unit as a distribution at the interface.

10. The interface information identification device according to claim 1, wherein the sample includes an adhesive layer between the first layer and the second layer, the adhesive layer bonding the first layer and the second layer, and
the identifying unit is configured to output, based on the identified information about the interface between the first layer and the second layer, information about an interface thermal resistance between the first layer and the adhesive layer.

11. The interface information identification device according to claim 1, wherein the identifying unit is configured to identify information about fatigue of the sample based on the temperature distribution detected by the detecting unit.

12. An interface information identification method comprising steps of:
emitting light to heat a planar sample, the sample including a first layer and a second layer overlapping the first layer;
homogenizing an intensity distribution of the emitted light to irradiate an entire surface of the first layer of the sample with the light;
detecting a temperature distribution on a surface of the second layer of the sample; and
identifying information about an interface between the first layer and the second layer of the sample based on the detected temperature distribution.

13. A non-transitory computer readable storage medium storing a program for causing a computer to execute functions of:
emitting light to heat a planar sample, the sample including a first layer and a second layer overlapping the first layer;
homogenizing an intensity distribution of the emitted light to irradiate an entire surface of the first layer of the sample with the light;
detecting a temperature distribution on a surface of the second layer of the sample; and
identifying information about an interface between the first layer and the second layer of the sample based on the detected temperature distribution.

14. An internal information identification device comprising:
a light source;
an irradiating unit configured to homogenize an intensity distribution of light emitted from the light source toward a planar sample to irradiate an entire surface of the sample with the light;
a detecting unit configured to detect, at an opposite side of the sample from the irradiating unit, a temperature distribution on a back side of the sample; and
an identifying unit configured to identify information about an internal condition of the sample based on an amplitude and a phase lag of the temperature distribution detected by the detecting unit.

15. The internal information identification device according to claim 14, wherein the identifying unit is configured to identify information about a through-plane thermal diffusivity of the sample based on an amplitude and a phase lag of the temperature distribution detected by the detecting unit and output the identified information about the through-plane thermal diffusivity of the sample as a distribution in the sample.

16. The internal information identification device according to claim 14, wherein the identifying unit is configured to identify information about fatigue inside the sample based on an amplitude and a phase lag of the temperature distribution detected by the detecting unit and output the identified information about the fatigue inside the sample as a distribution in the sample.

17. (canceled)
